(19) United States
(12) Patent Application Publication
(10) Pub. No.: US 2008/0281625 A1
(43) Pub. Date: Nov. 13, 2008

(54) SUBSTRATE PROCESSING APPARATUS, LICENSE MANAGEMENT PROGRAM, LICENSE INFORMATION SERVING APPARATUS, LICENSE INFORMATION PROVIDING PROGRAM, LICENSE MANAGEMENT SYSTEM, AND RECORDING MEDIUM

(75) Inventor: Keiichiro SHIKI, Nirasaki-Shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: TOKYO ELECTON LIMITED, Minato-ku (JP)

(21) Appl. No.: 12/175,968

(22) Filed: Jul. 18, 2008

Related U.S. Application Data
(63) Continuation of application No. PCT/JP2006/325940, filed on Dec. 26, 2006.

(30) Foreign Application Priority Data
Jan. 19, 2006 (JP) 2006-011219

(51) Int. Cl. G06Q 99/00; H04L 9/32

(52) U.S. Cl. 705/1; 726/19; 726/18

(57) ABSTRACT

A disclosed substrate processing apparatus that processes a wafer under control of software includes a license information reception portion that periodically receives license information related to the software from a license information serving apparatus connected to the substrate processing apparatus via a network; a license information analysis portion that analyzes the license information to extract address information of the license information serving apparatus on the network from the license information; and a license determination portion that compares the extracted address information with the address information that is of the license information serving apparatus and stored in advance in the substrate processing apparatus. When the two pieces of the address information are mismatched, at least part of functions of the software is restricted.

### CROSS-REFERENCE TO RELATED APPLICATION

This application is a U.S. continuation application filed under 35 U.S.C. 111(a) claiming benefit under 35 U.S.C. 120 and 365(c) of PCT application JP2006/325940, filed Dec. 26, 2006. The foregoing application is hereby incorporated herein by reference.

### TECHNICAL FIELD

The present invention relates to a substrate processing apparatus, a license management program, a license information serving apparatus, a license information providing program, a license management system, and a recording medium. Specifically, the present invention relates to a substrate processing apparatus that processes a substrate in accordance with control by software, a license management program, a license information serving apparatus, a license information providing program, a license management system, and a recording medium.

### BACKGROUND ART

Generally, software users must observe a license contract of the software. There are various requirements in the license contract, which stipulate the number of users, the number of computers, a valid term, or the like, within which the software is allowed to be used.

Regarding software that runs on a substrate processing apparatus such as a semiconductor device fabrication apparatus or the like, a license contract may be made between a user and a manufacturer of the substrate processing apparatus. In this situation, the manufacturer of the substrate processing apparatus charges the user a software licensing fee and licenses the software when the user pays the fee. Specifically, the manufacturer of the substrate processing apparatus notifies the user of a license key or the like, and when the key or the like is input the software is released for use, as is the case with other software.

By the way, when the license contract concerned is valid between the manufacturer and the user and if the user resells the substrate processing apparatus to a third party, the manufacturer should be allowed to charge a new user the licensing fee on the sold apparatus.

Patent-related Document 1: Japanese Laid-Open Patent Application No. 2005-84889.

### DISCLOSURE OF THE INVENTION

### Problems to be Solved by the Invention

However, it has been difficult for the manufacturer to know that the substrate processing apparatus is resold, if there is no report from the users. As a matter of fact, it may be possible for the manufacturer to know that the apparatus is reinstalled somewhere from a report by a maintenance worker or the like sent off from the manufacturer. However, if the original user who has resold the apparatus is not cooperative, it is expected to be difficult to know the new user who has bought the apparatus.

In this case, the manufacturer cannot charge the new user for the licensing fee and has no option but to tolerate an abuse of the software, which creates disadvantages for the manufacturer.

By the way, a technique described in Patent-related Document 1 is able to manage licenses made for each instrument, but cannot appropriately prevent an abuse of the software for use in the instrument, if sold to another user.

The present invention has been made in view of the above, and is directed to a substrate processing apparatus, a license management program, a license information serving apparatus, a license information providing program, a license management system, and a recording medium, all of which can prevent software that runs on the substrate processing apparatus from being abusively used.

### Means of Solving the Problems

In order to solve the above problem, a first aspect of the present invention provides a substrate processing apparatus that processes a wafer under control of software. The substrate processing apparatus includes a license information reception portion that periodically receives license information related to the software from a license information serving apparatus connected to the substrate processing apparatus via a network; a license information analysis portion that analyzes the license information to extract address information of the license information serving apparatus on the network from the license information; and a license determination portion that compares the extracted address information with the address information that is of the license information serving apparatus and stored in advance in the substrate processing apparatus. When the two pieces of the address information are mismatched, at least a part of the functions of the software is restricted.

A second aspect of the present invention provides a license information serving apparatus to be connected to the above substrate processing apparatus via a network. The license information serving apparatus includes a license information generation portion that generates license information in accordance with address information of the license information serving apparatus; and a license information transmission portion that transmits the license information to the substrate processing apparatus.

According to the above substrate processing apparatus or the above license information serving apparatus, the software that runs on the substrate processing apparatus can be appropriately prevented from being abusively used.

### EFFECTS OF THE INVENTION

According to the present invention, there are provided a substrate processing apparatus, a license management program, a license information serving apparatus, a license information providing program, a license management system, and a recording medium, all of which can prevent software that runs on the substrate processing apparatus from being abusively used.

### BRIEF DESCRIPTION OF THE DRAWING

FIG. 1 shows a schematic configuration of a substrate processing apparatus according to an embodiment of the present invention;

FIG. 2 shows a schematic configuration of a system controller and a network, according to a first embodiment of the present invention;

FIG. 3 shows an embodiment of a hardware configuration of a license key server according to an embodiment of the present invention;

FIG. 4 shows an embodiment of functional configurations of a license key server and the substrate processing apparatus, according to the first embodiment of the present invention;

FIG. 5 is a flowchart for explaining a process procedure of the initial setting process in the license key server when an initial key is input;

FIG. 6 is a flowchart for explaining a process procedure in a substrate processing apparatus when the initial key is received;

FIG. 7 is a flowchart for explaining a process procedure when a license is to be renewed in a substrate processing apparatus;

FIG. 8 is a flowchart for explaining a license key renewal procedure in a license key server;

FIG. 9 shows a configuration example of a system controller and a network, according to a second embodiment of the present invention;

FIG. 10 shows a configuration example of a system controller and a network, according to a third embodiment of the present invention;

FIG. 11 is another schematic configuration of a substrate processing apparatus, according to an embodiment of the present invention;

FIG. 12 is yet another schematic configuration of a substrate processing apparatus, according to an embodiment of the present invention;

FIG. 13 is a cross-sectional view of a second process unit;

FIG. 14 is a perspective view illustrating a schematic configuration of a second process ship;

FIG. 15 shows a schematic configuration of a dry air supplying system for driving units in a second load-lock unit; and

FIG. 16 shows a configuration example of a system controller in a substrate processing apparatus.

### BEST MODE OF CARRYING OUT THE INVENTION

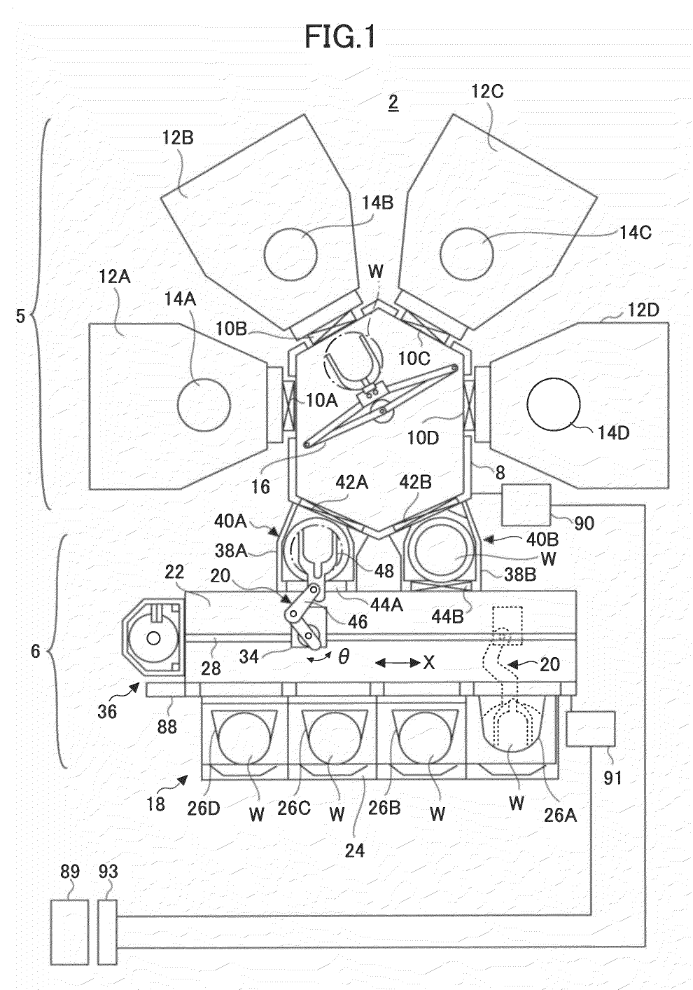

Referring to the accompanying drawings, embodiments of the present invention will be described. FIG. 1 shows a schematic example of a configuration of a substrate processing apparatus according to an embodiment of the present invention.

In FIG. 1, a substrate processing apparatus 2 is mainly composed of a processing system 5 in which various processes such as film deposition, diffusion, etching or the like are performed on a semiconductor wafer (substrate) W, or an object to be processed, and a transfer system 6 by which the wafer W is carried into and out of the processing system 5. The processing system 5 is composed of a transfer chamber 8 that can be evacuated and four process chambers 12A through 12D that are connected to the transfer chamber via corresponding gate valves 10A through 10D. The process chambers 12A through 12D are configured to perform the same or different processes on the wafer W. The process chambers 12A through 12D are provided with corresponding susceptors 14A through 14D on which the wafer W is placed. In addition, the transfer chamber 8 is provided with a transfer arm 16 that is telescopic and pivotable, which enables the wafer W to be transferred to-and-fro between the process chambers 12A through 12D, or between load-lock chambers described later.

On the other hand, the transfer system 6 is composed of a cassette stage 18 on which wafer cassettes are placed and a transfer stage 22 by which the delivery arm 20 is driven so as to transfer the wafer W. The cassette stage 18 is provided with a wafer cassette table 24 on which the plural wafer cassettes 26A through 26D (four wafer cassettes in the illustrated example) are placed. Each of the wafer cassettes 26A through 26D stores, for example, up to 25 wafers in multiple stages at constant intervals. The transfer stage 22 is provided with a linear guide rail 28 that extends along the longitudinal direction at and around the center of the transfer stage 22. The delivery arm 20 supported by a linear motor drive stage 34 can move fast, precisely, and linearly along the linear guide rail 28 without contacting the rail 28, utilizing electric energy into which magnetic flux from a magnet is converted using a moving coil.

In addition, there are provided an orienter 36 as a positioning tool to position the wafers W at one end of the transfer stage 22, and load-lock chambers 38A, 38B in the middle of the transfer stage 22. The load-lock chambers 38A, 38B are adapted to be evacuated and made to communicate with the transfer chamber 8. The load-lock chambers 38A, 38B are provided with wafer stages 40A, 40B to support the wafer W, respectively. The load-lock chamber 38A is flanked by gate valves 42A, 44A that allow communication with the transfer chamber 8 and the transfer stage 22, respectively. Similarly, the load-lock chamber 38B is flanked by gate valves 42B, 44B that allow communication with the transfer chamber 8 and the transfer stage 22, respectively. By the way, a transfer portion is composed at least of the transfer arm 16 and the delivery arm 20.

The substrate processing apparatus 2 further includes a system controller that controls the operation of the processing system 5, the transfer system 6, or the like, and an operation controller 88 disposed at the same end of the transfer stage 22.

The operation controller 88 has a display unit, an input device, or the like made of, for example, a Liquid Crystal Display. For example, the operation controller 88 displays operation states of the substrate processing apparatus 2 and accepts instructions input through a touch pen or the like.

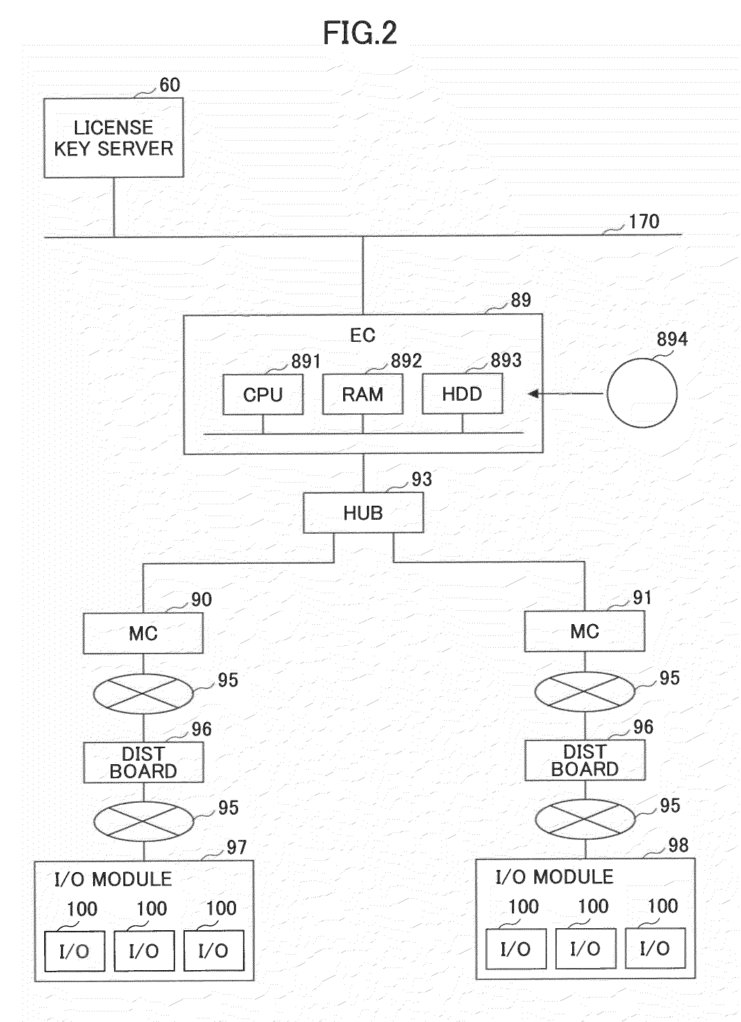

FIG. 2 shows a schematic configuration of a system controller and a network, according to a first embodiment of the present invention. As shown in FIG. 2, the system controller includes an equipment controller (EC) 89, two module controllers (MCs) 90, 91, and a switching hub 93 that connects the EC 89 and the MCs 90, 91.

The EC 89 is a main controlling portion (master controlling portion) that controls the MCs 90, 91 and administers the entire operation of the substrate processing apparatus 2. In addition, the EC 89 has a CPU 891, a RAM 892, an HDD 893, or the like. The CPU 891 sends control signals to each of the MCs 90, 91 in accordance with a processing method of the wafers W, or a program corresponding to a recipe determined in the operation controller 88 (FIG. 1) by the user, so as to control the processing system 5, the transfer system 6, or the like. Moreover, the EC 89 provides a license management function of the software that controls the substrate process in the substrate processing apparatus 2. The license management function is described later.

The switching hub 93 switches between the MCs 90, 91 as a connection destination in accordance with the control signal from the EC 89.

The MCs 90, 91 are sub controlling portions (slave controlling portions) that control the operation of the processing system 5 and the transfer system 6. The MCs 90, 91 are connected to input/output (I/O) modules 97, 98, respectively, via GHOST networks 95 and DIST (distribution) boards 96. The GHOST networks 95 are composed of LSIs called a General High-Speed Optimum Scalable Transceiver (GHOST) mounted on a MC board of each of the MCs 90, 91. To the GHOST network 95 may be connected to plural I/O modules. In the GHOST network 95, the MCs 90, 91 correspond to masters and the I/O modules correspond to slaves.

The I/O module 97 is composed of plural I/O portions 100 connected to corresponding components (called “end devices” below) in the processing system 5, sends control signals to each end device and receives an output signal from each device. The end devices connected to corresponding I/O portions 100 in the I/O module 97 may include, for example, mass flow controllers (MFCs) of an ammonia gas supply line and a hydrogen fluoride gas supplying line, a pressure gauge, an automatic pressure controller (APC) valve, an MFC of an nitrogen gas supply line, all of which are provided in the process chambers 12A through 12D, a transfer arm 16 in the transfer chamber 8, or the like (FIG. 1).

By the way, the I/O module 98 has the same configuration as the I/O module 97 and is connected to the transfer system 6 in a similar manner as the MC 90 and the I/O module 97 are connected to the processing system 5. Namely, the end devices connected to the I/O portions 100 in the I/O module 98 may include, for example, the linear motor drive stage 34, the delivery arm 20, both of which are provided in the transfer stage 22, and the gate valves 42A, 44A, 42B, 44B or the like of the load-lock chambers 38A, 38B (FIG. 1).

In addition, to each of the GHOST networks 95 are connected I/O boards (not shown) that control inputting and outputting digital, analog, and serial signals in the I/O portions 100.

In the substrate processing apparatus 2, when a certain process is performed on the wafer W, the CPU 891 of the EC 89 sends out, in accordance with the program corresponding to the recipe of the process, control signals to the desired end devices via the I/O portions 100 in the GHOST networks 95 and the I/O module 97, so as to carry out the process in the process chamber 12A or the like.

In the system controller of FIG. 2, the plural end devices are not directly connected to the EC 89 but connected to the I/O portions 100 which constitute the I/O module 97(98) in the form of modules. Then, the I/O module 97(98) is connected to the EC 89 via the MCs 90(91) and the switching hub 93. Therefore, signal communications systems can be simplified.

In addition, the control signals transmitted from the CPU 891 of the EC 89 include addresses of the I/O portions 100 connected to corresponding end devices and addresses of the I/O modules 97, 98 that are composed of the I/O portions 100. Since the switching hub 93 can refer to the I/O module addresses included in the control signals and I/O portion addresses included in a GHOST control signal from the MC 90(91), the switching hub 93 and the MC 90(91) do not have to query the CPU 891 about a transmission destination of each control signal. Therefore, smooth communications of the control signals can be realized.

The system controller is connected to a license key server 60 installed in a fabrication plant via a network 170 such as a Local Area Network or the like, which is provided in the same fabrication plant. The network 170 may be a wired or wireless network. The license key server 60 includes a computer such as a personal computer or the like that provides the substrate processing apparatus 2 with a license key. The license key has data to certify a license (use permit) of software that runs on the substrate processing apparatus 2. Namely, use of predetermined software in the substrate processing apparatus 2 according to this embodiment of the present invention is restricted partially or totally until an appropriate license key is input.

By the way, the system controller may be connected to a manufacturing execution system (MES) that manages fabrication procedures in the entire fabrication plant where the substrate processing apparatus 2 is installed. The MES can feed real time information on processes performed in the plant back to an enterprise resource planning (not shown) in cooperation with the system controller, and makes decisions on the processes taking account of workloads in the entire plant.

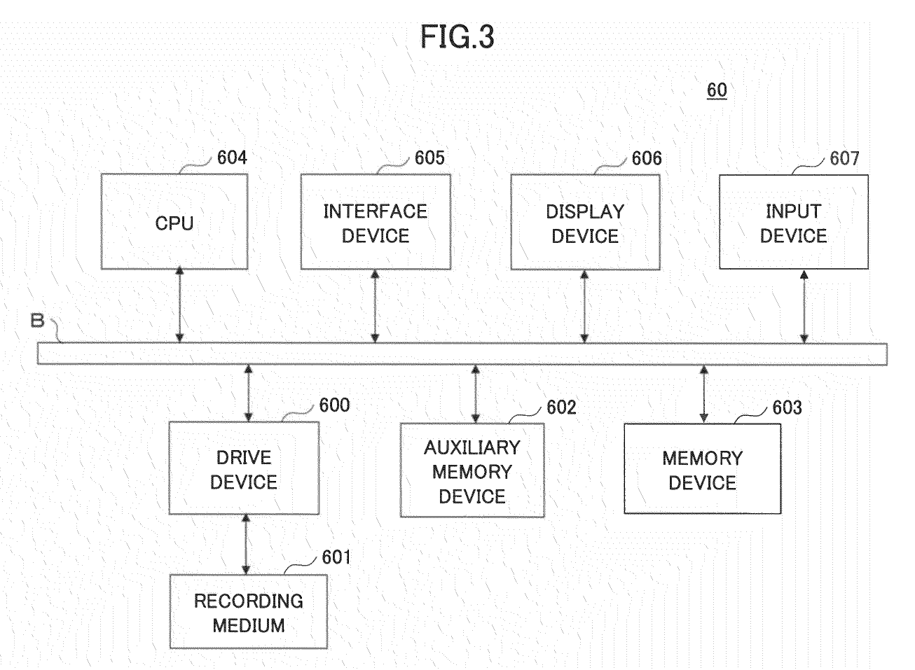

Next, the license key server 60 is described. FIG. 3 shows an example of a hardware configuration of the license key server according to the embodiment of the present invention. The license key server 60 according to this embodiment of the present invention is configured to include a drive device 600, an auxiliary memory device 602, a memory device 603, a CPU 604, an interface device 605, a display device 606, an input device 607 or the like, all of which are mutually connected via a bus B.

The program that exerts a predetermined function in the license key server 60 may be available in the form of recording medium 601 such as a floppy (registered trade mark) disk, a hard disk, a magneto-optic disk, a CD-ROM, a CD-R, a CD-RW, a DVD-ROM, a DVD-RAM, a DVD-RW, a DVD+RW, a magnetic tape, a non-volatile memory card, a ROM, or the like. When the recording medium 601 storing the program is placed in the drive device 600, the program is installed from the recording medium 601 to the auxiliary memory device 602 via the drive device 600. By the way, the program may be downloaded not from the recording medium 601 but via the network.

The auxiliary memory device 602 stores the installed program, necessary files and/or data. The memory device 603 reads the program from the auxiliary memory device 602 and stores the program, when receiving start-up instructions. The CPU 604 performs functions of the license key server 60 in accordance with the program stored in the memory device 603. The functions of the license key server 60 may be performed in accordance with an operating system (OS) running in the CPU 604 of the license key server 60. In addition, after the program is written into memories of the function extension boards and/or function extension units, a CPU or the like provided in various function extension boards and/or function extension units inserted into the license key server 60 may perform part or entirety of processes in accordance with the program.

By the way, the program may be in the form of object code, program code implemented by interpreter, script data supplied to the OS, or the like.

The interface device 605 is used as an interface for connection to the network 170, an example of which is a network interface card (NIC) or the like. The display device 606 displays a GUI or the like in accordance with the program. The input device 607 is composed of a key board, a mouse, or the like, and accepts various operation instructions.

The license key providing function by the license key server 60 and the license management function by the EC 89 of the substrate processing apparatus 2 constitute a license management system for the substrate processing apparatus 2.

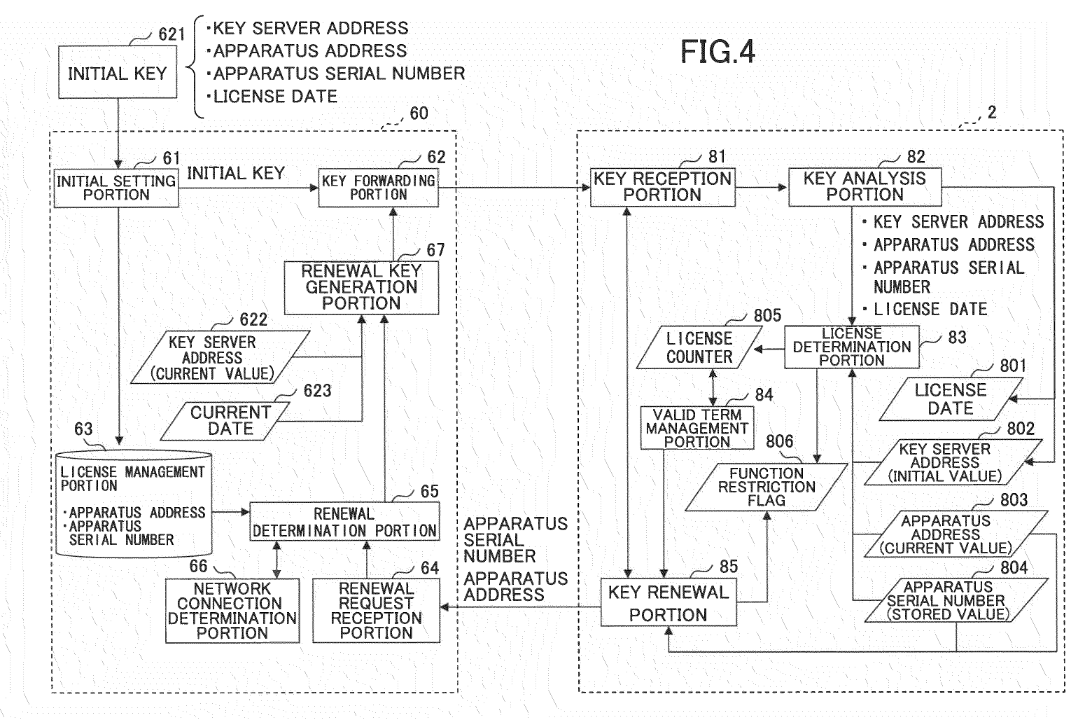

FIG. 4 shows an example of functional configurations of the license key server and the substrate processing apparatus, according to the first embodiment of the present invention.

In FIG. 4, the license key server 60 is composed of an initial setting portion 61, a key forwarding portion 62, a license management portion 63, a renewal request reception portion 64, a renewal determination portion 65, a network connection determination portion 66, a renewal key generation portion 67, or the like. Functions corresponding to these portions are performed by the CPU 604 executing the program installed in the license key server 60.

The initial setting portion 61 performs initial settings in order to remove function restrictions of the software in the substrate processing apparatus 2 when receiving an initial key 621. The initial key 621 corresponds to the license key that is to be input to start using the software in the substrate processing apparatus 2, and is preferably generated by the manufacturer of the substrate processing apparatus 2.

In this embodiment of the present invention, the initial key 621 is based on an IP address (key server address) allocated for connecting the license key server 60 to the network 170, another IP address (apparatus address) allocated for connecting the substrate processing apparatus 2 to the network 170, a serial number (apparatus serial number) of the substrate processing apparatus 2, and a date (license date) when the license key (initial key) is generated, and generated in accordance with a predetermined algorithm (for example, an encryption algorithm or the like, and referred to as a “key generation algorithm” below). By the way, the key generation algorithm has to be invertible and bi-directional, and allows for restoration of constituent information (the key server address, the apparatus address, the apparatus serial number, the license date) from the initial key 621. In addition, the key generation algorithm has to be kept secret from the user of the substrate processing apparatus.

When the initial key 621 is generated by the manufacturer, the user of the substrate processing apparatus 2 determines the key server address and the apparatus address, and then provides the manufacturer with the determined addresses and the apparatus serial number through the mail, e-mail, or the like. The manufacturer generates the initial key 621 in accordance with the provided information using the key generation algorithm. Then, the manufacturer stores the generated initial key 621 in a recording medium such as a CD-ROM, a floppy (registered trade mark) disk, or the like and delivers the recording medium to the user. Or, the manufacturer transmits the generated initial key 621 to the user through a network. By the way, the initial key 621 may be input to the license key server 60 by not only a worker of the manufacturer but also the user.

The initial setting portion 61 decrypts (analyzes) the initial key 621 and causes the license management portion 63 to store the apparatus address and the apparatus serial number included in the initial key 621, as an initial setting process in response to the input of the initial key 621. The initial setting portion 61 instructs the key forwarding portion 62 to forward the initial key 621 to the substrate processing apparatus 2.

The license management portion 63 manages apparatus-specific information for uniquely identifying the substrate processing apparatus 2 to be the subject of the software licensing. In this embodiment of the present invention, either one of the apparatus address and the apparatus serial number, or both, correspond to the apparatus-specific information. By the way, it is preferable that the license management portion 63 manage the encrypted apparatus-specific information. This is to prevent abusive removal of function restriction provided on the unlicensed substrate processing apparatus 2, which may happen if an ill-willed user rewrites the apparatus-specific information.

The renewal request reception portion 64 receives a renewal request for renewal of the license key from the substrate processing apparatus 2 when the license key such as the initial key or the like is about to expire. The renewal request includes the apparatus-specific information. Namely, the license key such as the initial key or the like, which determines a term of validity, is renewed periodically, thereby maintaining the software license in the substrate processing apparatus 2.

The renewal determination portion 65 determines whether the sender of the license key renewal request is the substrate processing apparatus 2 that has been licensed, and causes the network connection determination portion 66 to inspect whether the license key server 60 is properly connected to the network 170, so as to determine whether the license key renewal request should be approved.

The renewal key generation portion 67 generates another license key which is used to renew the term of validity when the renewal request is approved. This license key is referred to as a renewal key. The renewal key is based on the key server address, the apparatus address, the apparatus serial number and the license date, and generated in accordance with the key generation algorithm. It should be noted that a current number (the key server address 622) that is set in the license key server 60 at the time of generating the renewal key is used as the key server address. In addition, the apparatus address and the apparatus serial number managed by the license management portion 63 are used. Moreover, as the license date, a date (a current date 623) indicated by a timer of the license key server 60 at the time of generating the renewal key is used. The renewal key generation portion 67 generates the renewal key and instructs the key forwarding portion 62 to forward the renewal key to the substrate processing apparatus 2.

Then, the key forwarding portion 62 forwards the initial key or the renewal key to the substrate processing apparatus 2.

The substrate processing apparatus 2 is functionally composed of a key reception portion 81, a key analysis portion 82, a license determination portion 83, a term management portion 84, a key renewal portion 85, or the like, as shown in FIG. 4. Functions by these portions are performed by the CPU 891 executing the program installed in the HDD 893 of the EC 89, a ROM (not shown) or the like. The program may be installed, for example, through a recording medium such as the CD-ROM 894 (FIG. 2), a network, or the like, or may be pre-installed at the time of shipping the substrate processing apparatus 2.

The key reception portion 81 receives the license key (the initial key 621 or the renewal key) forwarded from the license key server 60.

The key analysis portion 82 decrypts the received license key so as to extract the key server address, the apparatus address, the apparatus serial number, and the license date that have been included in the license key. When the key analysis portion 82 receives the initial key 621, the key analysis portion 82 stores the initial value of the key server address as the key server address 802 in a predetermined memory area. In addition, the key analysis portion 82 updates the license date 801 in accordance with the extracted license date every time a license key is received.

The license determination portion 83 determines validity of the license key in accordance with information extracted from the received license key, namely, the key server address 802 stored as the initial value, the present value of the apparatus address 803, the apparatus serial number 804 pre-stored in a ROM (not shown) or the like at the time of shipping of the substrate processing apparatus 2. When the license key is determined to be invalid, the license determination portion 83 turns a function restriction flag “ON”. The function restriction flag 806 is flag information that partially or entirely restricts the use of functions of the software in the substrate processing apparatus 2. Namely, the software that controls functions of the substrate processing apparatus 2 and requires licensing based on the license contract refers to the function restriction flag 806 when the functions are requested to be performed. This software performs the functions when the function restriction flag is OFF, and refuses to perform the functions when the function restriction flag is ON.

The term management portion 84 manages relative time elapsed from when the license key is received, so as to detect expiration of the valid term of the license key. The term management portion 84 uses a license counter 805 for detecting the expiration of the valid term of the license key. The license counter 805 is a counter that is initialized when receiving the license key and incremented per a unit time period (for example, per day). The term management portion 84 instructs the key renewal portion 85 to renew the license key when the license counter 805 reaches a value indicating the valid term of the license key, or when the license counter 805 reaches a value indicating a predetermined period within the valid term of the license key. By the way, an abusive extension of the valid term is effectively prevented, since the valid term is managed through the relative time measured by the license counter 805, while the valid term can be abusively extended by changing the date of the timer of the substrate processing apparatus 2 if the valid term is managed through the absolute time.

The key renewal portion 85 transmits the license key renewal request to the license key sever 60 in response to a request from the term management portion 84.

FIG. 4 has shown a one-on-one relationship between the license key server 60 and the substrate processing apparatuses 2. However, one licensing key server 60 may provide plural substrate processing apparatus 2 with the license keys.

Next, a process procedure in the license key server 60 and the substrate processing apparatus 2 is explained. The following processes are performed by the CPU 604 of the license key server 60 and the CPU 891 of the EC 89, which execute the corresponding programs installed in the license key server 60 and the EC 89.

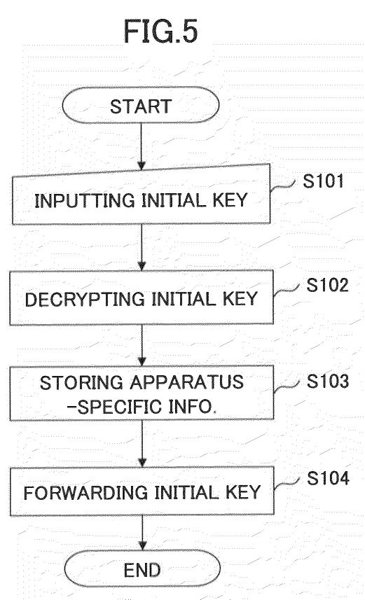

FIG. 5 is a flowchart for explaining a process procedure of the initial setting process in the license key server 60 at the time of inputting the initial key.

At Step S101, the initial key 621 provided by the manufacturer is input to the license key server 60 by the user of the substrate processing apparatus 2, a worker from the manufacturer, or the like. In response to the input initial key 621, the initial setting portion 61 decrypts the initial key 621 to obtain the key server address, the apparatus address, the apparatus serial number, the license date, or the like in accordance with a predetermined algorithm (referred to as “key decryption algorithm” below) that performs an inverse operation of the key generation algorithm (S102). As stated above, the key server address, the apparatus address, the apparatus serial number, the license date, or the like, all of which are decrypted from the initial key 621, are provided to the manufacturer from the user in advance.

Next, the license management portion 63 stores at least the apparatus address and the apparatus serial number as the apparatus-specific information among the pieces of information decrypted from the initial key 621 by the initial setting portion 61 (S103). Then, the initial setting portion 61 outputs the initial key 621 to the key forwarding portion 62, which in turn forwards the initial key 621 to the substrate processing apparatus 2 via the network 170 (S104).

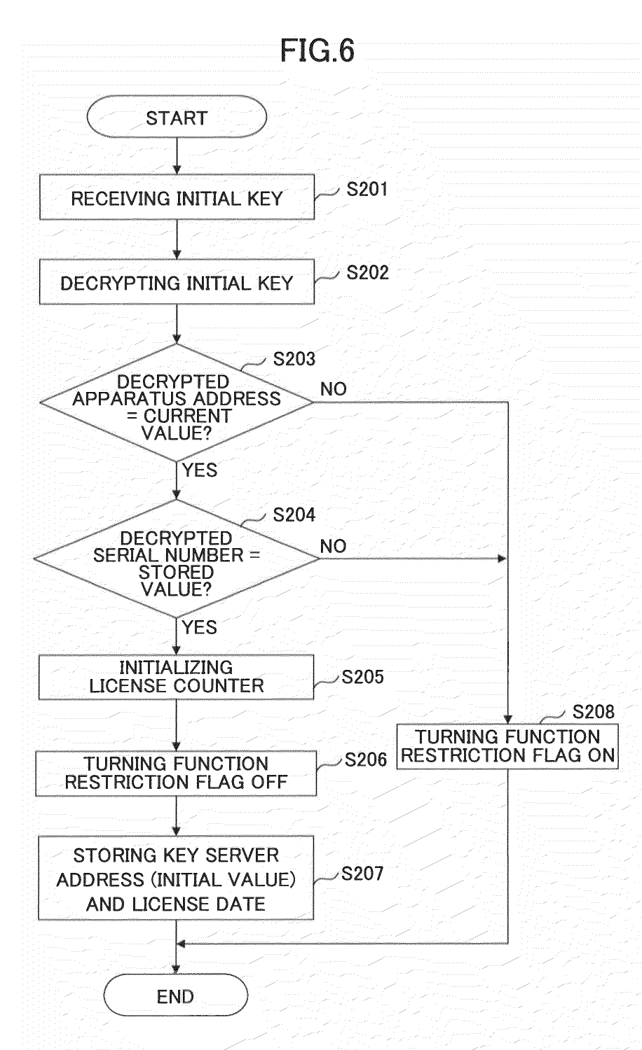

Next, a process procedure in the substrate processing apparatus 2 that receives the initial key 621 is explained. FIG. 6 is a flowchart for explaining the process procedure in the substrate processing apparatus 2 at the time of receiving the initial key.

The key reception portion 81 requests the key analysis portion 82 to analyze the initial key 621 received from the license key server 60 (S201). The key analysis portion 82 decrypts the initial key 621 in accordance with the key decryption algorithm so as to obtain the key server address, the apparatus address, the apparatus serial number, the license date, or the like (S202).

Next, the license determination portion 83 determines validity of the initial key 621 in accordance with the obtained apparatus-specific information. Namely, when the obtained apparatus address is coincident with the current apparatus address 803 (currently stored in the substrate processing apparatus 2) (S203: YES), and the obtained apparatus serial number is coincident with the apparatus serial number 804 stored in the substrate processing apparatus 2 in advance (S204: YES), the initial key 621 is determined to be issued to the substrate processing apparatus 2 and thus valid.

When the initial key 621 is determined to be valid, the license determination portion 83 initializes the license counter 805 (for example, resets the counter to “0”) (S205), and then turns the function restriction flag “OFF” (S206). Therefore, the software can be used in the substrate processing apparatus 2 within the valid term of the initial key 621 in this case.

After the initial key 621 is determined to be valid, the key analysis portion 82 stores the key server address decrypted from the initial key 621 as an initial value of the key server address 802 and the license date decrypted from the initial key 621 as the license date 801 (S207).

On the other hand, when at least one of the apparatus address and the apparatus serial number is different (S203 or S204: NO), the license determination portion 83 determines the initial key 621 to be invalid and turns the function restriction flag “ON” (S208). Therefore, some or all of the functions to be exerted by the software are restricted in the substrate processing apparatus 2.

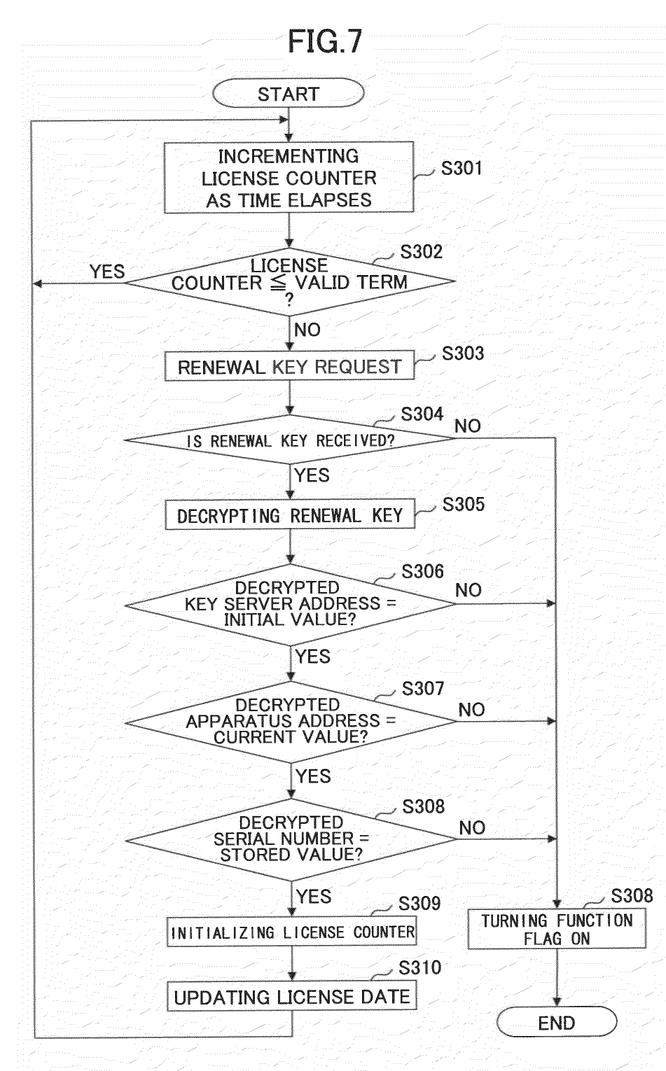

Next, a process procedure of renewing the license is explained, which is performed in the substrate processing apparatus 2 when the valid time of the initial key 621 or the renewal key is expired. FIG. 7 is a flowchart for explaining the process procedure for renewing the license in the substrate processing apparatus 2.

The term management portion 84 increments the license counter 805 every time a predetermined period of unit time (for example, per one day) is elapsed throughout the valid term of the license key (S301), and compares the number indicated by the license counter 805 with a value indicating the valid term (S302). The valid term of the license key may be optionally determined depending on needs. For example, when the license counter 805 is incremented per one day and the valid term of the license key is one year, the value indicating the end of the valid term is “365”.

When the license counter 805 reaches the value indicating the end of the valid term or a predetermined point of time ahead the end of the valid term (S302: NO), the term management portion 84 notifies the key renewal portion 85 to that effect. In response to the notification, the key renewal portion 85 transmits the renewal request of the license key to the license key server 60 (S303). By the way, the renewal request of the license key is accompanied by the current apparatus address 803 and the apparatus serial number 804. After the renewal request of the license key is transmitted, the key renewal portion 85 stands ready for a predetermined period of time until the renewal key is received by the key reception portion 81.

Upon reception of the renewal key from the license key server 60 (S304: YES), the key reception portion 81 notifies the key renewal portion 85 to that effect, and outputs the received renewal key to the key analysis portion 82. With the notification from the key reception portion 81, the key renewal portion 85 exits from the ready state.

The key analysis portion 82 decrypts the renewal key in accordance with the key decryption algorithm so as to obtain the key sever address, the apparatus address, the apparatus serial number, the license date, or the like (S305).

Next, the license determination portion 83 determines the validity of the renewal key. Namely, the license determination portion 83 compares the decrypted key server address (the current IP address of the license key server 60) with the initial value of the key server address 802 (namely, the key server address included in the initial key 621), so as to determine whether the license key server 60 is relocated on the network (S306). When the two key server addresses are coincident with each other (S306: YES), it is determined that the license key server 60 is not moved within the license valid term. If the two key server addresses are different (S306: NO), it is determined that the license key server 60 has been moved.

When the two key server addresses are coincident (S306: YES), the license determination portion 83 compares the decrypted apparatus address (namely, the apparatus address included in the initial key 621) with the current apparatus address 803, so as to determine whether the renewal key corresponds to the substrate processing apparatus 2 and whether the substrate processing apparatus 2 is relocated on the network (S307). When these two apparatus addresses are coincident with each other, it is determined that the renewal key corresponds to the substrate processing apparatus 2 and the substrate processing apparatus 2 is not moved. When these two apparatus addresses are different, it is determined that the renewal key does not correspond to the substrate processing apparatus 2 or the substrate processing apparatus 2 has been moved.

When these two apparatus addresses are coincident with each other (S307: YES), the license determination portion 83 compares the decrypted apparatus serial number (namely, the apparatus serial number included in the initial key 621) with the apparatus serial number 804 stored in the substrate processing apparatus 2 in advance, so as to determine whether the renewal key corresponds to the substrate processing apparatus 2. When the two serial numbers are coincident, it is determined that the renewal key corresponds to the substrate processing apparatus 2. When the serial numbers are different, it is determined that the renewal key does not correspond to the substrate processing apparatus 2.

In all the steps S306 through S308, when the values to be compared are coincident, the renewal key is valid. Therefore, the license counter 805 is initialized by the license determination portion 83 (S309), and the license date is updated to a date when the renewal key is decrypted (S310) by the key analysis portion 82. Since the license counter 805 is initialized, the valid term is extended and the steps S301 and beyond are subsequently performed.

On the other hand, when a predetermined period of time elapses until the renewal key is received after the license key renewal request is issued, namely, when waiting time is up (S304: NO), the key renewal portion 85 turns the function restriction flag 806 “ON” (S308). In addition, when the license determination portion 83 determines that the license key is invalid (any one of S306 through S308: NO), the license determination portion 83 turns the function restriction flag 806 “ON” (S308). Therefore, a part of or entire functions of the software are restricted in the substrate processing apparatus 2.

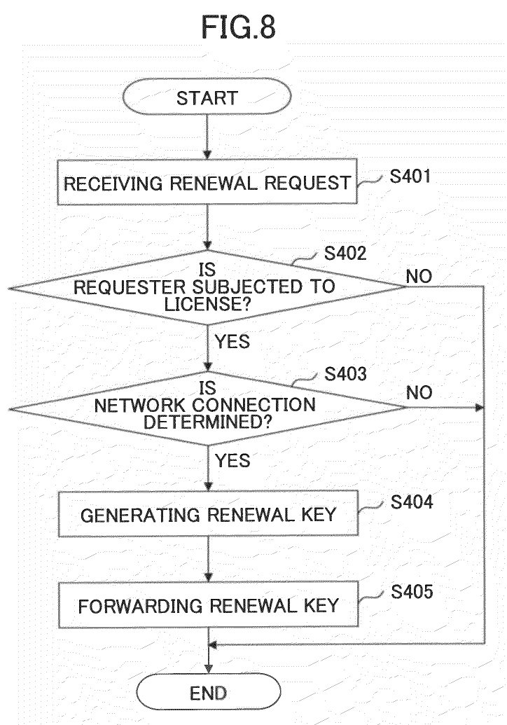

Next, a process procedure by the license key server 60 when the license key renewal is requested from the substrate processing apparatus 2 is explained. FIG. 8 is a flowchart for explaining the license key renewal procedure in the license key server.

When receiving the license key renewal request from the key renewal portion 85 of the substrate processing portion 2, the renewal request reception portion 64 outputs the apparatus serial number 804 included in the renewal request and the current apparatus address 803 to the renewal determination portion 65 (S401).

The renewal determination portion 65 compares a set of the apparatus serial number 804 and the apparatus address 803 received from the renewal request reception portion 64 with a set of the apparatus serial number and the apparatus address stored in the license management portion 63, so as to determine whether a sender of the license key request is the substrate processing apparatus 2 to which the license key has at least once been issued (S402). When the set of the apparatus serial number 804 and the apparatus address 803 is not included in a list managed by the license management portion 63 (S402), the renewal determination portion 65 determines that the sender of the license renewal request is not the licensee and stops subsequent processes. Therefore, the renewal key is not issued in this case. By the way, if only the apparatus address 803 is different, the substrate processing apparatus 2 is probably relocated on the network. Therefore, the relocation of the substrate processing apparatus 2 can be detected at Step S402.

When the set of the apparatus serial number 804 and the apparatus address 803 is included in the list stored in the license management portion 63, the renewal determination portion 65 causes the network connection determination portion 66 to confirm whether the license key server 60 is connected to the network 170 (S403). Such confirmation may be carried out, for example, by issuing a ping command, issuing an IP packet to a particular host computer connected to the network 170, and confirming that the IP packet is transmitted back. The particular host computer connected to the network is preferably designated by the manufacturer of the substrate processing apparatus 2. By the way, the significance of the confirmation of the connection to the network 170 is described later.

When it is determined that the license key server 60 is not connected to the network 170 (S403: NO), the renewal determination portion 65 stops subsequent processes. Therefore, the renewal key is not issued. On the other hand, when it is determined that the license key server 60 is connected to the network 170 (S403: YES), the renewal determination portion 65 requests the renewal key generation portion 67 to generate the renewal key.

The renewal key generation portion 67 generates the renewal key using the key generation algorithm in accordance with the current key server address 622, the current date 623, the apparatus serial number and the apparatus address that are stored in the license management portion 63 and related to the substrate processing apparatus 2 to which the renewal request is directed (S404). The generated renewal key is forwarded to the substrate processing apparatus 2 by the key forwarding portion 62 (S405). In response to the forwarded renewal key, the substrate processing apparatus 2 performs Steps S305 and beyond in FIG. 7.

As stated above, according to the license management system of the first embodiment of the present invention, even when the substrate processing apparatus 2 is resold and relocated, the software for the substrate processing apparatus 2 is effectively prevented from being abusively used.

Namely, when the user desires to continuously use the software in the substrate processing apparatus 2, the license key server 60 has to be connected via the network. This is because the renewal key cannot be provided if the license key server 60 is disconnected. When the user resells the substrate processing apparatus 2 and the license key server 60, the IP address of the key server address 622 has to be changed so as to correspond to a network provided where the apparatus 2 is relocated. As a result, the key server address 622 included in the renewal key becomes different from the initial key server address 802 stored in the substrate processing apparatus 2 (S306 in FIG. 7: No), and thus the function restriction flag is turned “ON”. By the way, it is difficult to maintain the key server address 622 in order to prevent the “after-relocation” key server address 622 from becoming different from the initial key server address 802. This is because the license key server 60 cannot be normally connected to the network provided where the license key server 60 is moved if the key server address is not changed, while the license key server 60 is confirmed to be connected to the network by the connection determination portion 65 when the renewal key needs to be generated (S403 in FIG. 8).

In addition, when only the substrate processing apparatus 2 is resold and relocated and even if the connection between the license key server 60 and the substrate processing apparatus 2 is maintained via the Internet or the like, use of the software for the substrate processing apparatus 2 can also be restricted. When the substrate processing apparatus 2 is relocated, the apparatus address has to be changed so as to be accessible to the network available where the apparatus is relocated. As a result, the apparatus address 803 included in the license key renewal request from the substrate processing apparatus 2 is no longer the same as the apparatus address managed by the license management portion 63. Therefore, the renewal determination portion 65 stops generating the renewal key (S403 in FIG. 8). By the way, the relocation of the substrate processing apparatus 2 can be detected even if the renewal determination portion 65 functions. Namely, even when the renewal key is generated as requested while the renewal determination portion 65 performs no comparison in response to the license key renewal request from the substrate processing apparatus 2 and then transmitted to the substrate processing apparatus 2, the license determination portion 83 of the substrate processing apparatus 2 will detect the difference between the apparatus address included in the renewal key and the current apparatus address 803 (S307 in FIG. 7).

Moreover, when the validity of the license key is confirmed in the substrate processing apparatus 2, since the apparatus-specific information is also confirmed (S307, S308), the above-described license management can be performed per substrate processing apparatus 2. By the way, while the apparatus address and the apparatus serial number are used as the information to specify the substrate processing apparatus 2 in the first embodiment of the present invention, only either of the two pieces of information may be used. However, use of both pieces of information leads to higher reliability.

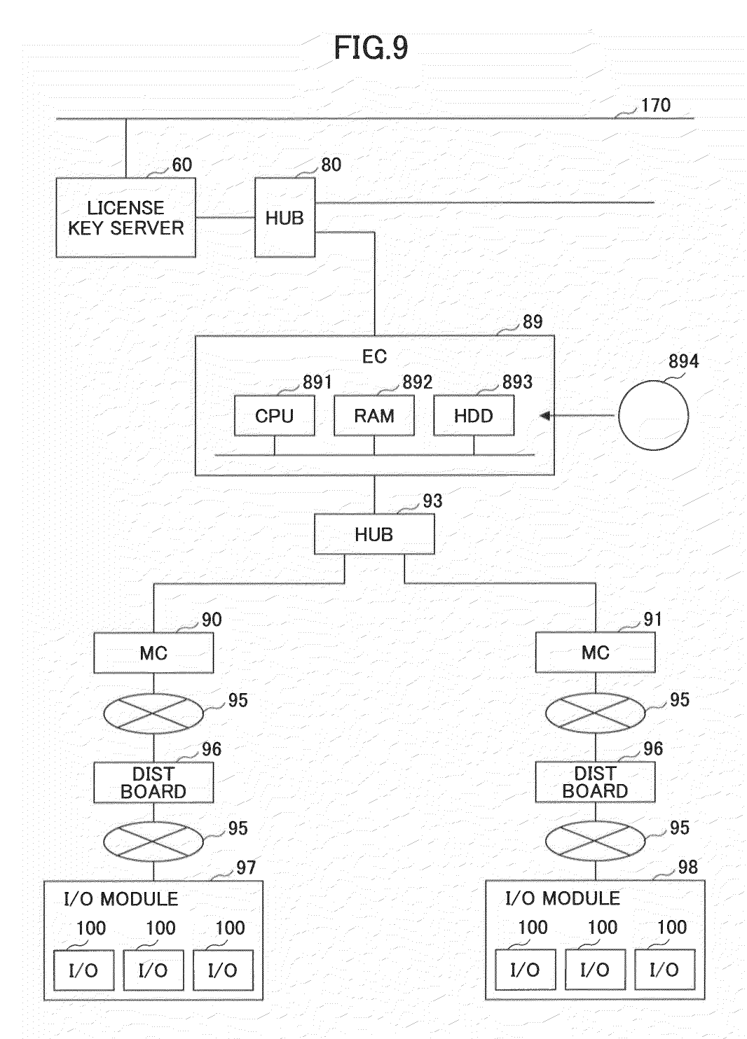

Next, a second embodiment of the present invention is described. FIG. 9 shows a configuration example of a system controller and a network according to the second embodiment of the present invention. In FIG. 9, like reference marks are given to like portions described in reference to FIG. 2, and repetitive explanation is omitted.

In FIG. 9, the license key server 60 has at least two connection ports (the interface devices 605 (FIG. 3) to the network. For example, the license key server 60 is provided with at least two NICs. One is connected to the network 170 and the other is connected to the EC 89 of the substrate processing apparatus 2. Namely, the substrate processing apparatus 2 is not directly connected to the network 170 in the second embodiment according to the present invention. Such a substrate processing apparatus 2 may be preferably used by a user who considers it unfavorable to directly connect the substrate processing apparatus 2 to the network from the viewpoint of security. By the way, when plural of the substrate processing apparatuses 2 are connected to one license key server 60, a switching hub 80 may be interposed between the license key server 60 and the plural substrate processing apparatuses 2. As is the case with the first embodiment, the license key server 60 and the substrate processing apparatus 2 are placed in the same fabrication plant. The schematic configuration (FIG. 1) of the substrate processing apparatus 2, the hardware configuration (FIG. 3) of the license key server 60, and the functional configuration (FIG. 4) of the license key server 60 and the substrate processing apparatus 2 which realize the license management system in the first embodiment may be applied to the second embodiment.

In addition, the license key server 60 and the substrate processing apparatus 2 according to the second embodiment of the present invention may carry out processes in the same manner as (FIGS. 5, 6, 7, and 8) the first embodiment of the present invention.

Since the substrate processing apparatus 2 is not connected directly to the network 170, the IP address (apparatus address) does not necessarily correspond to the network 170. The apparatus address is set to be an unchanging address designated by the manufacturer of the substrate processing apparatus 2, and the manufacturer may generate the initial key 621 in accordance with the unchanging address. Or, the IP address optionally set by the user may be presented along with the initial key issuance, based on which the initial key 621 can be generated. In either case, when only the substrate processing apparatus 2 is resold and relocated, the substrate processing apparatus 2 has to be connected to the network provided where the apparatus 2 is relocated in order to maintain the connection of the apparatus 2 to the license key sever 60, which requires a change of the apparatus address 803. As a result, the function restriction flag 806 is turned “ON”, thereby effectively avoiding an abusive use of the software.

By the way, when the license key server 60 is resold and relocated as well, the key server address 622 cannot avoid being changed. Therefore, the function restriction flag 806 is turned “ON” also in this case, thereby effectively avoiding an abusive use of the software.

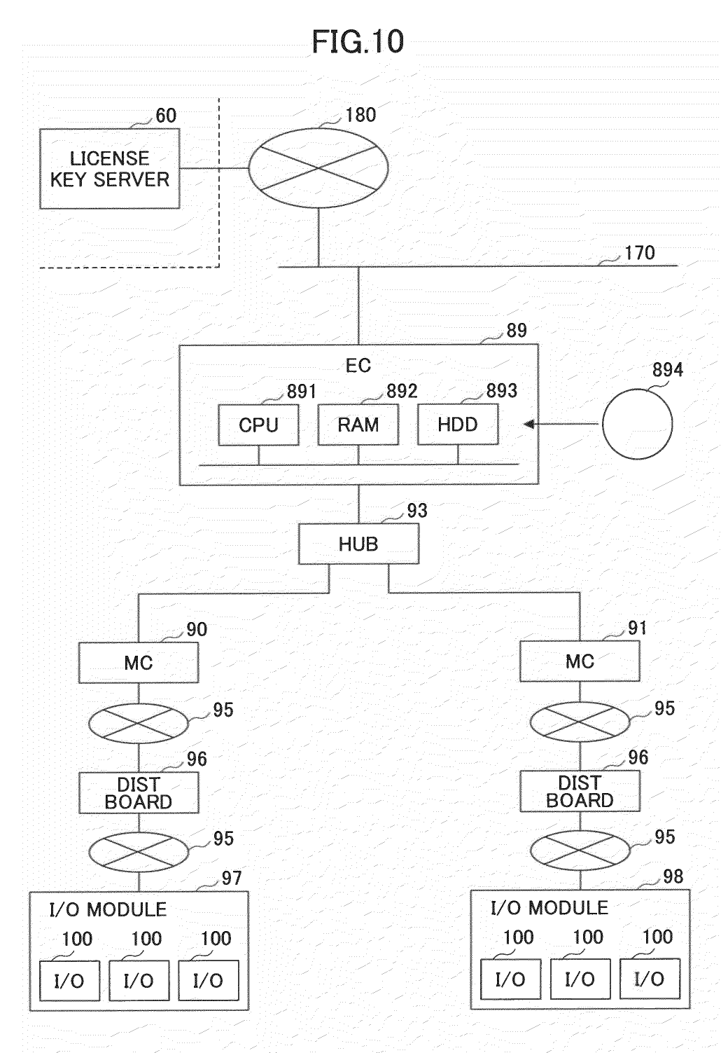

Next, a third embodiment of the present invention is described. FIG. 10 shows a configuration example of a system controller and a network according to the third embodiment of the present invention. In FIG. 10, like reference marks are given to like portions described in reference to FIG. 2, and repetitive explanation is omitted.

In FIG. 10, the license key server 60 is connected to the substrate processing apparatus 2 via a wide area network 180 such as the Internet. The substrate processing apparatus is connected to the wide area network 180 via the network 170. The third embodiment of the present invention is considered preferable when the license key server 60 is installed at the manufacturer of the substrate processing apparatus 2. The schematic configuration (FIG. 1) of the substrate processing apparatus 2, the hardware configuration (FIG. 3) of the license key server 60, and the functional configuration (FIG. 4) of the license key server 60 and the substrate processing apparatus 2 which realize the license management system in the first embodiment may be applied to the third embodiment.

In addition, the license key server 60 and the substrate processing apparatus 2 according to the third embodiment of the present invention may carry out processes in the same manner as the first embodiment (FIGS. 5, 6, 7, and 8) of the present invention.

However, when the license key server 60 is installed in the manufacturer and a worker of the manufacturer is allowed to carry out the initial setting, the initial key 621 is not input at the time of the initial setting, but the key server address, the apparatus address, the apparatus serial number, and the license date may be input. Then, the license key server 60 may generate the initial key 621 in accordance with the input data.

Since the license key server 60 is never resold along with the substrate processing apparatus 2 in the third embodiment of the present invention, only the substrate processing apparatus 2 may be resold. In this case, since the apparatus address of the substrate processing apparatus 2 needs to be changed when relocated, the changed apparatus address becomes different from the apparatus address used at the time of generating the initial key. Therefore, the function restriction flag is turned “ON”, thereby avoiding an abusive use of the software.

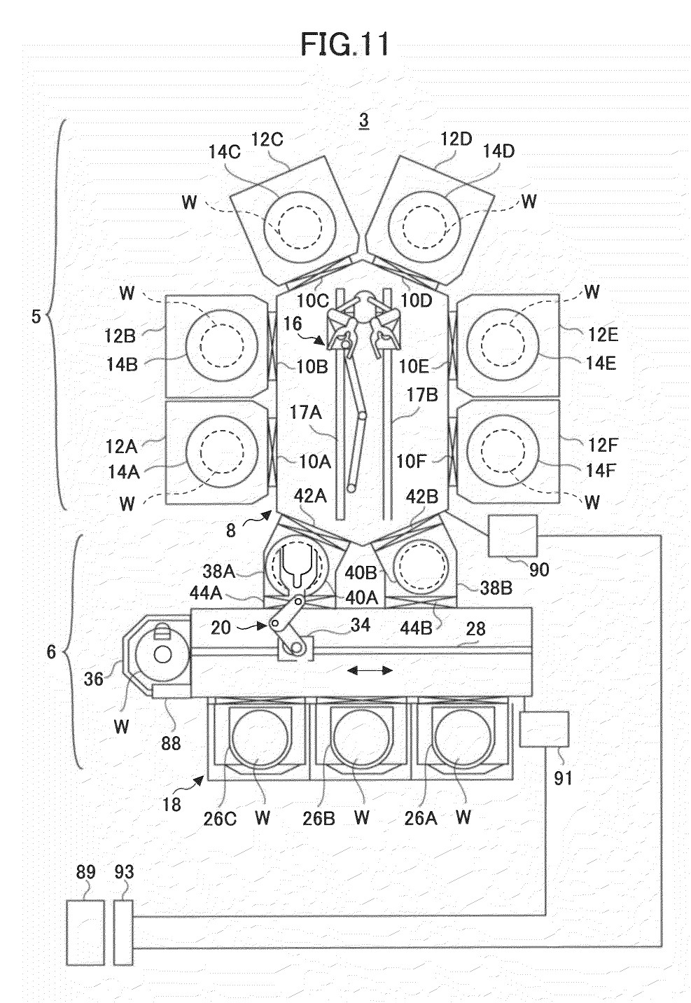

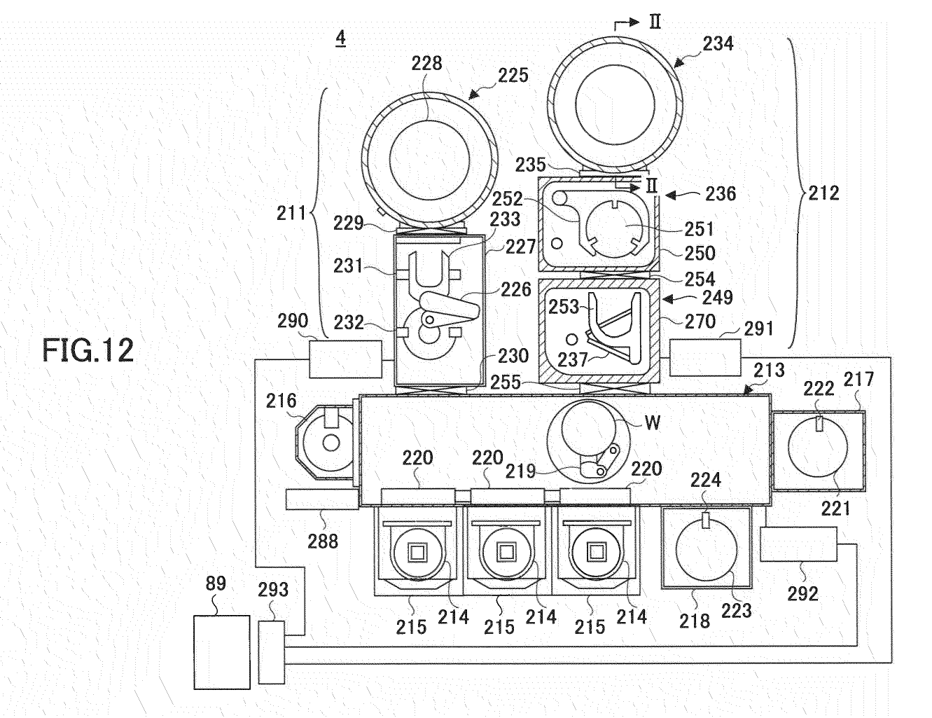

By the way, the substrate processing apparatus 2 in the first through the third embodiments of the present invention may be configured as shown in FIGS. 11 and 12. FIG. 11 is a schematic configuration of a second substrate processing apparatus 2 according to another embodiment of the present invention. In FIG. 11, like reference marks are given to like portions in FIG. 1, and repetitive explanation is omitted.

A substrate processing apparatus 3 shown in FIG. 11 is different from the substrate processing apparatus 2 shown in FIG. 1 in that the substrate processing apparatus 3 has six process chambers (12A through 12F) whereas the substrate processing apparatus 2 has the four process chambers (12A through 12D). In addition, the transfer chamber 8 has a different configuration, and the transfer arm 16 in the substrate processing apparatus 3 moves linearly along rails 17A, 17B and pivotably around a pivotal axis so as to transfer the wafer W.

By the way, the EC 89 in the substrate processing apparatus 3 performs processes in the same manner as the EC 89 in the substrate processing apparatus 2.

FIG. 12 is a schematic configuration of a third substrate processing apparatus according to yet another embodiment of the present invention.

In FIG. 12, a substrate processing apparatus 4 includes a first process ship 211 in which a reactive ion etching (RIE) process is performed on the wafer W, a second process ship 212 in which a chemical oxide removal (COR) process and a post heat treatment (PHT) process are performed on the wafer W that has undergone the RIE process, the second process ship 212 being disposed parallel with the first process ship 211, and a loader unit 213 as a common transfer chamber to which the first and the second process ships 211, 212 are connected, the loader unit 213 being rectangular in this embodiment.

In addition to the first and the second process ships 211, 212, three stages 215 on which front opening unified pods (FOUPs) 214 that house twenty five wafers W may be placed, an orienter 216 that is to position the wafer W transferred from the FOUPs 214, and first and second integrated metrology systems (IMS) (Therma-Wave, Inc.) 217, 218 are connected to the loader unit 213.

The first and the second process ships 211, 212 are connected to a longitudinal side wall of the loader unit 213 and disposed so as to oppose the three stages 215 with the loader unit 213 therebetween. The orienter 216 is disposed at one end in the longitudinal direction of the loader unit 213. The first IMS 217 is disposed at the other end of the loader unit 213, whereas the second IMS 218 is disposed in parallel with the three stages 215.

The loader unit 213 has in its insides a transfer arm mechanism 219 that is configured in the form of a scalar-type dual arm and transfers the wafer W, and three load ports 220 as wafer loading slots that are disposed on a side wall of the loader unit 213 so as to correspond to the three stages 215. The transfer arm mechanism 219 draws the wafers W from the FOUPs 214 placed on the stages 215 through the load ports 220 and loads the wafers W to and from the first process ship 211, the second process ship 212, the orienter 216, the first IMS 217, and the second IMS 218.

The first IMS 217, which is an optical monitor, has a stage 221 on which the wafer W is placed and an optical sensor 222 that is directed toward the wafer W placed on the stage 221. The first IMS 217 monitors surface dimensions of the wafer W. For example, the first IMS 217 measures a thickness of a surface layer and a critical dimension of wiring grooves, gate electrodes, or the like. The second IMS 218, which is also an optical monitor, has a stage 223 and an optical sensor 224, similar to the first IMS 217, so as to measure the number of particles on the front surface of the wafer W.

The first process ship 211 has a first process unit 225 as a first vacuum process chamber in which the RIE process is performed on the wafer W and a first load-lock unit 227 that houses a first transfer arm 226 that is configured in the form of a link-type single pick and passes the wafer W through to the first process unit 225.

The first process unit 225 has a cylindrical process chamber, and upper and lower electrodes that are disposed inside the process chamber. The distance between the upper and the lower electrodes is set so that the RIE process is appropriately performed on the wafer W. In addition, the lower electrode has on its top an electrostatic chuck (ESC) 228 that utilizes Coulomb force or the like to clamp the wafer W on its top.

In the first process unit 225, process gasses are introduced and an electric field is generated between the upper electrode and the lower electrode so as to produce plasma. Thus, reactive ion etching (RIE) is performed on the wafer W, utilizing ions and radicals in the plasma.

In the first process ship 211, the inside of the first process unit 225 is maintained at a reduced pressure, while the inside of the loader unit 213 is maintained at atmospheric pressure. In this situation, the first load-lock unit 227 is provided with a vacuum gate valve 229 at a connecting section with the first process unit 225 and an atmospheric gate valve 230 at a connecting section with the loader unit 213, thereby serving as a preparatory vacuum transfer chamber whose inner pressure is adjustable.

Inside the first load-lock unit 227, the first transfer arm 226 is disposed substantially in the center of the unit 227, a first buffer 231 is disposed closer to the first process unit 225, and a second buffer 232 is disposed closer to the loader unit 213 from the first transfer arm 226. With this, the first and the second buffers 231, 232 are located in the middle of a passage of a supporting portion (pick) 233 disposed at the distal end of the first transfer arm 226, and temporarily support the wafer W that has undergone the RIE process at an upper portion of the passage of the supporting portion 233, thereby enabling smooth replacement of the RIE-processed wafer W with an unprocessed wafer W in the first process unit 225.

The second process ship 212 has a second process unit 234 as a second vacuum process chamber in which the COR process is performed on the wafer W, a third process unit 236 as a third vacuum process chamber in which the PHT process is performed on the wafer W, the third process unit 236 being connected to the second process unit 234 via a vacuum gate valve 35, and a second load-lock unit 249 that houses a second transfer arm 237 that is configured in the form of a link-type single pick and passes the wafer W through to and from the second process unit 234 and the third process unit 236.

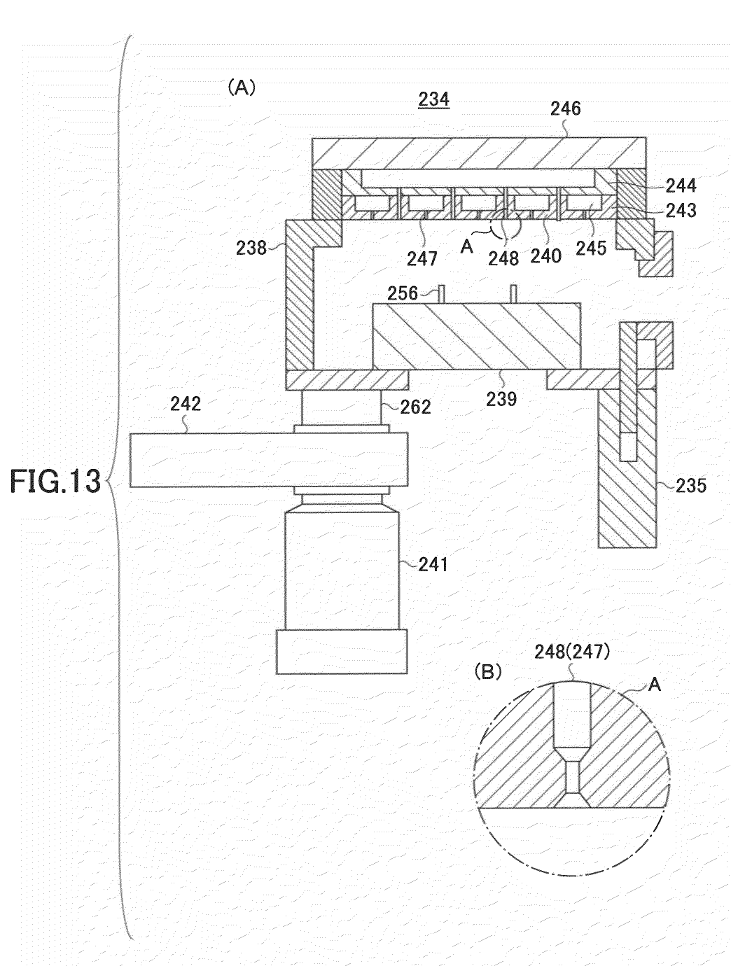

FIG. 13 is a cross-sectional view of the second process unit. FIG. 13(A) is a cross-sectional view taken along a II-II line in FIG. 12, and FIG. 13(B) is a magnified view of an A portion in FIG. 13(A).

In FIG. 13(A), the second process unit 234 has a cylindrical process chamber 238, an ESC 239 that is disposed inside the process chamber 238 as a wafer stage for the wafer W, a shower head 240 disposed in the upper portion of the process chamber 238, a turbo molecular pump (TMP) 241 that exhausts gasses or the like from the process chamber 238, an automatic pressure control valve 242 that is disposed between the process chamber 238 and the TMP 241, an adjustable butterfly valve that controls the inner pressure of the process chamber 238.

The ESC 239 has electrode plates (not shown) to which a direct voltage is to be applied. The ESC 239 attracts and supports the wafer W utilizing a Coulomb force or Johnson-Rahbeck force produced by the direct voltage. In addition, the ESC 239 has plural pusher pins 256 as lift pins that can protrude from the upper surface of the ESC 239. The pusher pins 256 recede into the ESC 239 when the ESC 239 attracts the wafer W and protrude from the upper surface of the ESC 239 so as to raise the wafer W after the wafer W undergoes the COR process and is transferred out from the process chamber 238.

The shower head 240 has a two-layer structure, namely, a lower layer portion 243 and an upper layer portion 244, both of which have a first buffer chamber 245 and a second buffer chamber 246. The first buffer chamber 245 and the second buffer chamber 246 are in communication with the process chamber 238 via gas through-holes 247 and 248, respectively. When the COR process is performed on the wafer W, NH₃ (ammonia) gas is introduced into the first buffer chamber 245 through an ammonia gas supplying line 257 (described later) and the introduced NH₃ gas is supplied to the process chamber 238 through the gas through-holes 247; and HF (hydrogen fluoride) gas is introduced into the second buffer chamber 246 through an HF supplying line 258 (described later) and the introduced HF gas is supplied to the process chamber 238 through the gas through-holes 248.

In addition, as shown in FIG. 13(B), openings of the gas through-holes 247, 248 to the process chamber 238 are formed into folding-fan shapes. This facilitates diffusion of the ammonia gas and the hydrogen fluoride gas in the process chamber 238. Moreover, the gas through-holes 247, 248 have a constriction in the middle, which can prevent deposits produced in the process chamber 238 from flowing backward in the gas through-holes 247, 248 and thus the first and the second buffer chambers 245, 246. By the way, the gas through-holes 247, 248 may be formed into spirals.

The second process unit 234 adjusts the inner pressure of the process chamber 238 and a volumetric flow ratio of the ammonia gas to the hydrogen fluoride gas, when the COR process is performed on the wafer W in the process unit 234.

Referring again to FIG. 12, the third process unit 236 has a process chamber 250 having a substantially rectangular parallelepiped shape, a stage heater 251 that is disposed in the process chamber 250 and serves as a wafer stage for the wafer W, and a buffer arm 252 that is to support temporarily the wafer W for adjusting a transfer sequence and is disposed above the stage heater 251.

The stage heater 251 is made of aluminum and has an oxide film formed on the aluminum surface. In addition, the stage heater 251 has a built-in heating wire or the like so as to heat the wafer W placed on the stage heater 251 up to a predetermined temperature. The buffer arm 252 can support temporarily the wafer W that has undergone the COR process at an upper portion of a passage of a supporting portion 253 with the second transfer arm 237, thereby enabling smooth replacement of the wafers W in the second process unit 234 and the third process unit 236.

In the third process unit 236, the temperature of the wafer W is adjusted while the PHT process is performed on the wafer W.

The second load-lock unit 249 has a transfer chamber 270 that houses the second transfer arm 237. The transfer chamber 270 has a substantially rectangular parallelepiped shape. In addition, the inner pressures of the second process unit 234 and the third process unit 236 are maintained at reduced pressure, while the inner pressure of the loader unit 213 is maintained at atmospheric pressure. In this situation, the second load-lock unit 249 is provided with a vacuum gate valve 254 at a connecting section with the third process unit 236 and an atmospheric door valve 255 at a connecting section with the loader unit 213, thereby serving as a preparatory vacuum transfer chamber whose inner pressure can be adjustable.

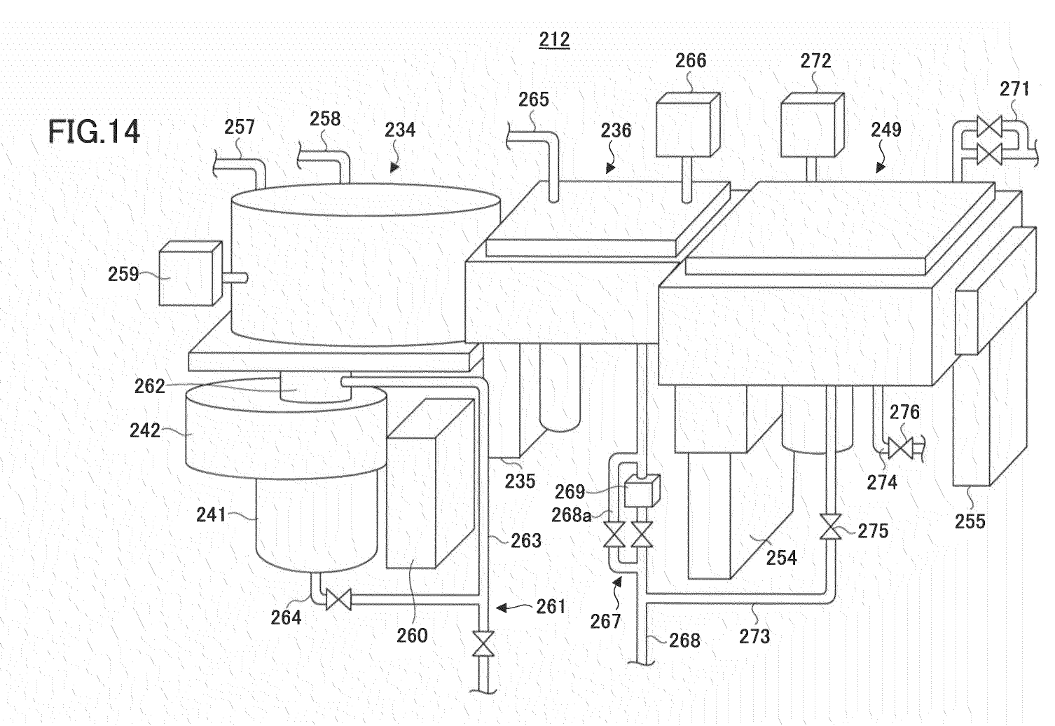

FIG. 14 is a perspective view illustrating a schematic configuration of the second process ship.

In FIG. 14, the second process unit 234 includes the ammonia gas supplying line 257 that is to supply the ammonia gas to the first buffer chamber 245, the hydrogen fluoride gas supplying line 258 that is to supply the hydrogen fluoride gas to the second buffer chamber 246, a pressure gauge 259 that measures the inner pressure of the process chamber 238, and a chiller unit 260 that supplies a cooling fluid to a cooling system (not shown) disposed in the ESC 239.

The ammonia gas supplying line 257 is provided with a mass flow controller (MFC) (not shown), which controls the flow rate of the ammonia gas supplied to the first buffer chamber 245. The hydrogen fluoride gas supplying line 258 is also provided with the MFC (not shown), which controls the flow rate of the hydrogen fluoride gas supplied to the second buffer chamber 246. The MFCs in the ammonia gas supplying line 257 and the hydrogen gas supplying line 258 operate cooperatively so as to adjust the volumetric flow ratio of the ammonia gas to the hydrogen fluoride gas supplied to the process chamber 238.

In addition, a second process unit exhaust system 261 connected to a dry pump (DP) (not shown) is disposed below the second process unit 234. The second process unit exhaust system 261 has an exhaust line 263 that is in communication with an exhaust duct 262 disposed between the process chamber 238 and the APC valve 242, and an exhaust line 264 connected to the exit of the TMP 241, thereby exhausting the gases or the like from the process chamber 238. By the way, the exhaust line 264 is connected to the exhaust line 263 in front of the DP.

The third process unit 236 includes a nitrogen (N₂) gas supplying line 265 that is to supply nitrogen gas to the process chamber 250 (FIG. 12), a pressure gauge 266 that measures the inner pressure of the process chamber 250, and a third process unit exhaust system 267 that evacuates the nitrogen gas or the like from the process chamber 250.

The nitrogen gas supplying line 265 is provided with an MFC (not shown), which controls a flow rate of the nitrogen gas supplied to the process chamber 250 (FIG. 12). The third process unit exhaust system 267 has a main exhaust line 268 that is in communication with the process chamber 250 of the third process unit 236 and connected to the main DP (not shown), an APC valve 269 provided in the middle of the main exhaust line 268, and an auxiliary exhaust line 268a that is branched from the main exhaust line 268 so as to circumvent the APC valve 269 and joined to the main exhaust line 268 in front of the DP. The APC valve 269 controls the inner pressure of the process chamber 250.

The second load-lock unit 249 includes a nitrogen gas supplying line 271 that supplies nitrogen gas to the transfer chamber 270 (FIG. 12) of the second load-lock unit 249, a pressure gauge 272 that measures the inner pressure of the transfer chamber 270, a second load-lock unit exhaust system 273 that evacuates the nitrogen gas or the like from the transfer chamber 270, and a vent line 274 that allows the transfer chamber 270 to be exposed to the atmosphere.

The nitrogen gas supplying line 271 is provided with an MFC (not shown), which controls the flow rate of the nitrogen gas supplied to the transfer chamber 270. The second load-lock unit exhaust system 273 is formed of one exhaust pipe that is in communication with the transfer chamber 270 and connected to the main exhaust line 268 of the third process unit exhaust system 267 in front of the DP. In addition, the second load-lock unit exhaust system 273 and the vent line 274 have an openable/closable exhaust valve 275 and a relief valve 276, respectively. The exhaust valve 275 and the relief valve 276 operate so as to adjust the inner pressure of the transfer chamber 270 at a pressure ranging from a predetermined vacuum level to atmospheric pressure.

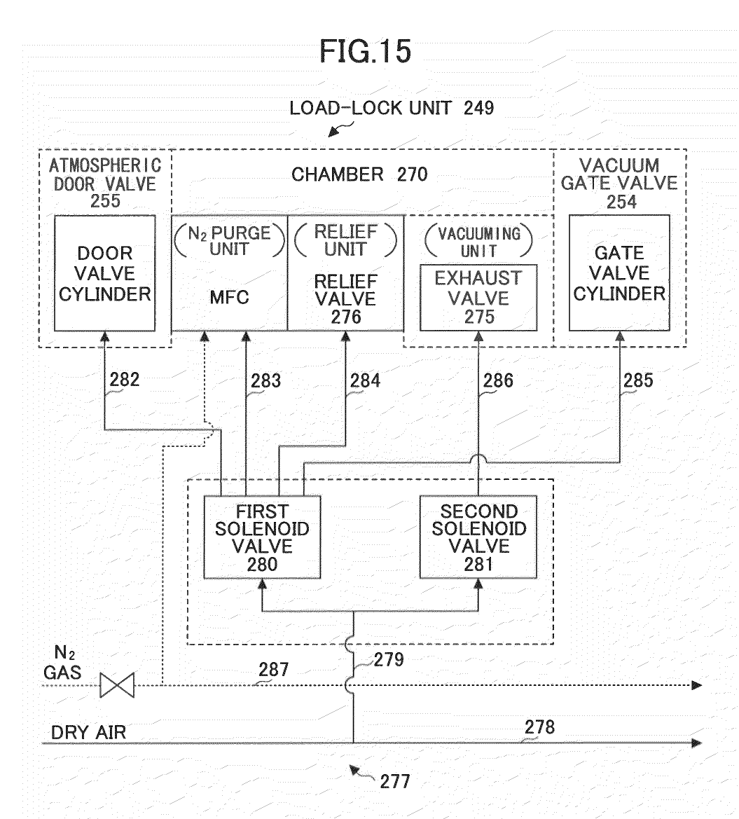

FIG. 15 is a schematic configuration of a dry air supplying system for driving the second load-lock unit.

In FIG. 15, the dry air from a dry air supplying system 277 for driving various elements of the second load-lock unit 249 is supplied to a door valve cylinder for driving a slide door of the atmospheric door valve 255, the MFC in the nitrogen gas supplying line 271 as an N₂ purge unit, a relief valve 276 of the vent line 274 as a relief unit for release to the atmosphere, the exhaust valve 275 of the second load-lock unit exhaust system 273 as a vacuuming unit, and a gate valve cylinder for driving a slide gate of the vacuum gate valve 254.

The dry air supplying system 277 includes an auxiliary dry air supplying line 279 that is branched from the main dry air supplying line 278 provided in the second process ship 212 (FIG. 12), and first and second solenoid valves 280, 281 connected to the auxiliary dry air supplying line 279.

The first solenoid valve 280 is connected to the door valve cylinder, the MFC, the relief valve 276, and the gate valve cylinder via dry air supplying lines 282, 283, 384, 285, respectively. By controlling the amount of the dry air supplied to the elements such as the door valve cylinder or the like, operations of these elements are controlled. In addition, the second solenoid valve 281 is connected to the exhaust valve 275 via a dry air supplying line 286 and controls operations of the exhaust valve 275 by controlling the amount of the dry air to be supplied to the exhaust valve 275.

By the way, the MFC in the nitrogen gas supplying line 271 is also connected to the nitrogen (N₂) gas supplying line 287.

In addition, the second process unit 234 and the third process unit 236 have corresponding dry air supplying systems which have the same configuration of the dry air supplying system 277 of the second load-lock unit 249.

Referring back to FIG. 12, the substrate processing apparatus 4 includes a system controller that controls the first process ship 211, the second process ship 212, and the loader unit 213, and an operation controller 288 disposed at one end in the longitudinal direction of the loader unit 213.

The operation controller 288 has a display portion made of, for example, a liquid crystal display (LCD), which displays operations of each constituting elements of the substrate processing apparatus 4, log information, or the like, as is the case with the operation controller 88 in FIG. 1.

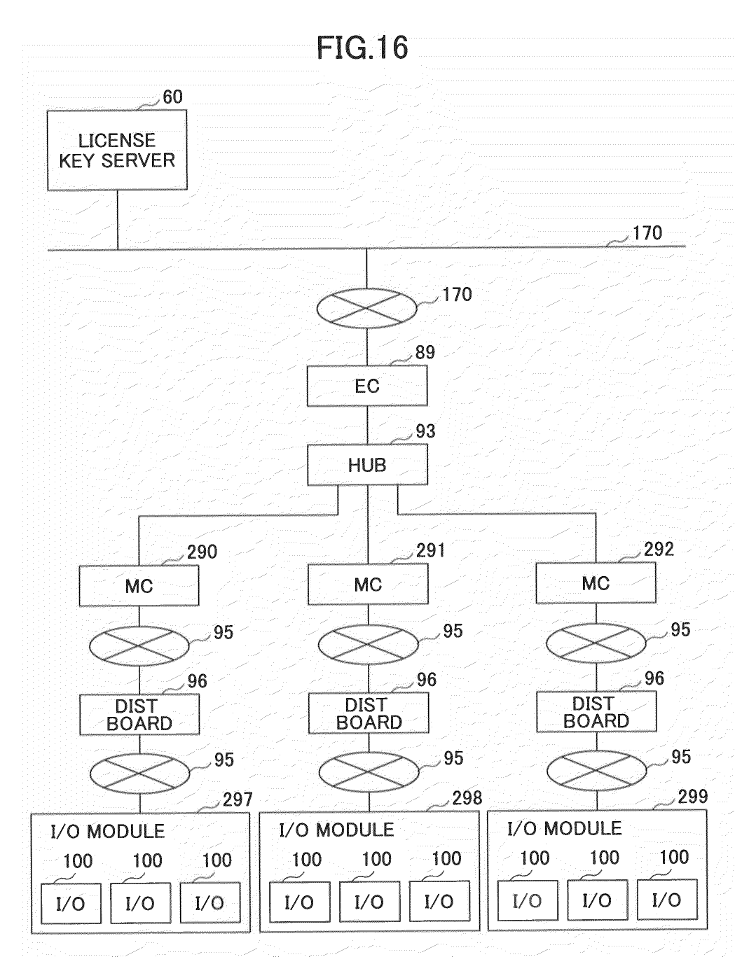

FIG. 16 shows a configuration example of a system controller in the third substrate processing apparatus. In FIG. 16, like reference marks are given to elements corresponding to the elements shown in FIG. 2.

In FIG. 16, MCs 290, 291, and 292 are auxiliary control portions (slave controlling portions) that control the first process ship 211, the second process ship 212, and the loader unit 213, respectively. The MCs are connected to corresponding I/O modules 297, 298, and 299 by DIST (distribution) boards 96 via GHOST networks 95, which is the same as FIG. 2.

In addition, the I/O modules 297, 298, and 299 have the same configuration as the I/O module 97 or 98 in FIG. 2, although these modules 297, 298, and 299 are different in that the I/O modules 297, 298, and 299 correspond to the first process ship 211, the second process ship 212, and the loader unit 213, respectively.

By the way, while FIG. 16 shows that the license key server 60 is connected to the EC 89 via the network 170, this configuration may be replaced with either one of the configurations shown in the second and the third embodiments of the present invention.

Although several preferred embodiments of the present invention have been explained in detail, the present invention is not limited to these embodiments, but various alterations and modifications are possible within the scope of the present invention set forth with the Claims.

1. A substrate processing apparatus that processes a wafer under control of software, the apparatus comprising:
a license information reception portion that periodically receives license information related to the software from a license information serving apparatus connected to the substrate processing apparatus via a network;
a license information analysis portion that analyzes the license information to extract address information of the license information serving apparatus on the network from the license information; and
a license determination portion that compares the extracted address information with the address information that is of the license information serving apparatus and stored in advance in the substrate processing apparatus,
wherein when the two pieces of the address information are mismatched, at least part of functions of the software are restricted.

2. The substrate processing apparatus of claim 1, wherein the license information analysis portion extracts apparatus-specific information having a specific value per the substrate processing apparatus from the license information, and
wherein the license determination portion compares the extracted apparatus-specific information with the apparatus-specific information of the substrate processing apparatus, and
wherein when the two pieces of the apparatus-specific information are mismatched, at least part of the functions of the software are restricted.

3. The substrate processing apparatus of claim 1, wherein the license information analysis portion extracts from the license information address information of the substrate processing apparatus for which the software is to be licensed,
wherein the license determination portion compares the extracted address information of the substrate processing apparatus with the address information set in the substrate processing apparatus, and
wherein when the two pieces of the address information are mismatched, at least part of the functions of the software are restricted.

4. The substrate processing apparatus of claim 1, wherein the stored address information of the license information serving apparatus is included in the license information received initially from the license information serving apparatus.

5. The substrate processing apparatus of claim 1, further comprising:
a term management portion that manages relative time elapsed from when the license information is received; and
a license information request portion that transmits a renewal request of the license information to the license information serving apparatus when the relative elapsed time reaches a predetermined point of time within a validity term of the license information.

6. The substrate processing apparatus of claim 5, wherein when the license information is not received within a predetermined period of time from when the license information renewal request is transmitted, at least part of the functions of the software are restricted.

7. A license management program comprising procedures for causing a substrate processing apparatus that processes a substrate under control of software to perform steps of:
receiving periodically license information related to the software from a license information serving apparatus connected to the substrate processing apparatus via a network;
analyzing the license information so as to extract address information of the license information serving apparatus on the network from the license information; and
comparing the extracted address information with the address information that is of the license information serving apparatus and is stored in advance in the substrate processing apparatus;
wherein when the two pieces of the address information are mismatched, at least part of functions of the software are restricted.

8. The license management program of claim 7, wherein the license information analyzing step extracts the apparatus-specific information having a specific value per the substrate processing apparatus from the license information,
wherein the address information comparing step compares the extracted apparatus-specific information with the apparatus-specific information of the substrate processing apparatus, and
wherein when the two pieces of the apparatus-specific information are mismatched, at least part of the functions of the software are restricted.

9. The license management program of claim 7, wherein the license information analyzing step extracts from the license information address information of the substrate processing apparatus for which the software is to be licensed,
wherein the address information comparing step compares the extracted substrate processing apparatus address information with the address information set in the substrate processing apparatus, and
wherein when the two pieces of the address information are mismatched, at least part of the functions of the software are restricted.

10. The license management program of claim 7, wherein the address information of the license information serving apparatus, the address information being stored in advance in the substrate processing apparatus, is included in the license information received initially from the license information serving apparatus.

11. The license management program of claim 7, further comprising procedures for the substrate processing apparatus to perform steps of:
measuring relative time elapsed from when the license information is received; and
transmitting a renewal request of the license information to the license information serving apparatus when the relative elapsed time reaches a predetermined point of time within a license valid term of the license information.

12. The license management program of claim 11, wherein when the license information is not received within a predetermined period of time from when the license information renewal information is transmitted, at least part of the functions of the software are restricted.

13. A computer-readable recording medium which stores the license management program of claim 7.

14. A license information serving apparatus to be connected to the substrate processing apparatus of claim 1 via a network, the license information serving apparatus comprising:
a license information generation portion that generates license information in accordance with address information of the license information serving apparatus; and
a license information transmission portion that transmits the license information to the substrate processing apparatus.

15. The license information serving apparatus of claim 14, further comprising a license management portion that manages specific information of the substrate processing apparatus for which the software is to be licensed,
wherein the license information generation portion generates the license information in accordance with the specific information managed by the license management portion.

16. The license information serving apparatus of claim 15, wherein the license management portion manages address information of the substrate processing apparatus for which the software is to be licensed, and
wherein the license information generation portion generates the license information in accordance with the address information of the substrate processing apparatus for which the software is to be licensed.

17. The license information serving apparatus of claim 15, further comprising:
a renewal request reception portion that receives a renewal request of the license information from the substrate processing apparatus; and
a renewal determination portion that compares the specific information of the substrate processing apparatus that sends the renewal request with the specific information managed in the license management portion so as to determine whether the license renewal is granted,
wherein the license information generation portion generates the license information when the renewal determination portion determines the license renewal is to be granted.

18. The license information serving apparatus of claim 14, further comprising a network connection determination portion that determines whether the license information serving apparatus is connected to the network,
wherein the license information generation portion generates the license information when the license information serving apparatus is determined to be connected to the network.

19. A license information providing program comprising procedures for causing a license information serving apparatus connected to a substrate processing apparatus of claim 1 via a network to perform steps of:
generating license information in accordance with address information of the license information serving apparatus; and
transmitting the license information to the substrate processing apparatus.

20. The license information providing program of claim 19, further comprising a procedure for causing the license information serving apparatus to perform a step of managing specific information of the substrate processing apparatus for which the software is licensed,
wherein the license information generating step generates the license information in accordance with the specific information managed according to the specific information managing step.

21. The license information providing program of claim 20, further comprising a procedure for causing the license information serving apparatus to perform a step of managing address information of the substrate processing apparatus for which the software is to be licensed,
wherein the license information generating step generates the license information in accordance with the address information of the substrate processing apparatus for which the software is to be licensed.

22. The license information serving apparatus of claim 20, further comprising procedures for causing the license information serving apparatus to perform steps of:
receiving a renewal request of the license information from the substrate processing apparatus; and
comparing the specific information of the substrate processing apparatus that sends the renewal request, the specific information being included in the renewal request, with the specific information managed according to the license information managing step so as to determine whether the license renewal of the license information is granted,
wherein the license information generating step generates the license information when the license renewal is determined to be granted in the specific information comparing step.

23. The license information providing program of claim 19, further comprising a procedure for the license information serving apparatus to perform a step of determining whether the license information serving apparatus is connected to the network,
wherein the license information generating step generates the license information when the license information serving apparatus is determined to be connected to the network.

24. A computer-readable recording medium which stores the license information providing program of claim 19.

25. A license management system comprising:
a substrate processing apparatus that processes a substrate under control of software; and
a license information serving apparatus that provides the substrate processing apparatus with license information related to the software,
wherein the substrate processing apparatus includes
a license information reception portion that periodically receives the license information related to the software,
a license information analysis portion that analyzes the license information to extract address information of the license information serving apparatus on a network from the license information,
a license determination portion that compares the extracted address information with the address information that is of the license information serving apparatus and stored in advance in the substrate processing apparatus,
wherein when the two pieces of the address information are mismatched, at least part of functions of the software are restricted.
